(19) United States
(12) Patent Application Publication
(10) Pub. No.: US 2022/0272544 A1
(43) Pub. Date: Aug. 25, 2022

(54) COMMUNICATION APPARATUS AND COMMUNICATION METHOD FOR 6GHz BAND FREQUENCY COORDINATION

(71) Applicant: Panasonic Intellectual Property Corporation of America, Torrance, CA (US)

(72) Inventors: Rojan CHITRAKAR, Singapore (SG); Lei HUANG, Singapore (SG); Yoshio URABE, Nara (JP)

(21) Appl. No.: 17/628,169

(22) PCT Filed: Jul. 15, 2020
(86) PCT No.: PCT/SG2020/050412

§ 371 Date: Jan. 18, 2022

(30) Foreign Application Priority Data
Jul. 31, 2019 (SG) 10201907069P

(51) Int. Cl. H04W 16/14; H04W 48/16; H04W 72/04; H04W 72/08

(52) U.S. Cl. CPC H04W 16/14; H04W 48/16; H04W 72/0453; H04W 72/082

(57) ABSTRACT

The present disclosure provides communication apparatus and communication method for 6 GHz band frequency coordination. A communication apparatus is provided, the communication apparatus comprising: a receiver, which, in operation, receives information identifying an operating channel of an access point (AP) in a channel that is different from the operating channel, the information further indicating whether transmission of a probe request frame before receiving an enabling signal in the operating channel is allowed; and circuitry, which, in operation, determines from the information whether to generate a probe request frame for transmission before receiving the enabling signal in the operating channel; and wherein the circuitry is further configured to scan for the enabling signal in the operating channel without transmitting the probe request frame, based on a determination that transmission of the probe request frame before receiving the enabling signal in the operating channel is not allowed.

### TECHNICAL FIELD

The present disclosure relates to communication apparatuses and methods for frequency coordination, and more particularly to communication apparatuses and methods for 6 GHz band frequency coordination.

### BACKGROUND

The USA FCC (Federal Communications Commission) has recently opened up the 6 GHz band for unlicensed use. The 6 GHz band will play an important role in achieving the throughput goals of upcoming wireless standards such as IEEE 802.11ax (HE), IEEE 802.11be (EHT), 3GPP 5G standards etc.

In order to protect the incumbent users, in the latest Notice for Proposed Rulemaking (NPRM), FCC has proposed rules for operation of unlicensed devices in the 6 GHz band. The following points in the NPRM are of particular relevance to this disclosure:
U-NII-5 sub-band (5.925-6.425 GHz) and U-NII-7 sub-band (6.525-6.875 GHz) are heavily used by point-to-point microwave links, including links that must maintain a high level of availability. Thus, these sub-bands permit “standard-power access points (AP)” using power levels of U-NII-1 and U-NII-3 bands to operate on frequencies determined by an AFC (Automated Frequency Coordination) system. U-NII stands for Unlicensed National Information Infrastructure.
U-NII-6 and U-NII-8 sub-bands are used by mobile stations where the location of the incumbent receivers is not easily determined from existing databases, making use of AFC difficult. Thus, these sub-bands may only permit indoor “low-power access point” using lower power levels of U-NII-2 bands.
Client devices may be permitted to operate across the entire 6 GHz band while under the control of either a standard-power AP or a low-power AP

However, there has been no discussion on communication apparatuses and methods for frequency coordination in the 6 GHz band.

There is thus a need for communication apparatuses and methods that provide feasible technical solutions for frequency coordination in the 6 GHz band. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for 6 GHz band frequency coordination.

According to a first embodiment of the present disclosure, there is provided a communication apparatus comprising: a receiver, which, in operation, receives information identifying an operating channel of an access point (AP) in a channel that is different from the operating channel, the information further indicating whether transmission of a probe request frame before receiving an enabling signal in the operating channel is allowed; and circuitry, which, in operation, determines from the information whether to generate a probe request frame for transmission before receiving the enabling signal in the operating channel; and wherein the circuitry is further configured to scan for the enabling signal in the operating channel without transmitting the probe request frame, based on a determination that transmission of the probe request frame before receiving the enabling signal in the operating channel is not allowed.

According to a second embodiment of the present disclosure, there is provided an access point (AP) configured to advertise information of its operating channel in a channel that is different from the operating channel, the AP comprising: circuitry, which, in operation, generates a signal comprising information indicating whether transmission of probe request frames before receiving an enabling signal in the operating channel is allowed; and a transmitter, which, in operation, transmits the generated signal to one or more communication apparatuses in the channel.

According to a third embodiment of the present disclosure, there is provided a communication method comprising: receiving information identifying an operating channel of an access point (AP) in a channel that is different from the operating channel, the information further indicating whether transmission of a probe request frame is allowed before receiving an enabling signal in the operating channel; determining based on the information whether to generate a probe request frame for transmission before receiving the enabling signal in the operating channel; and scanning for the enabling signal in the operating channel without transmitting the probe request frame, based on a determination that transmission of the probe request frame is not allowed before receiving an enabling signal in the operating channel.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram for an AFC system architecture.

FIG. 2 depicts a flow diagram illustrating an Initial frequency availability inquiry and registration between an AP/AP Controller and an AFC system.

FIG. 3 shows an example of an AFC Enabling Signal according to various embodiments.

FIG. 4 shows a format of a Transmit Power Envelope element according to various embodiments.

FIG. 5 shows a format of a Trigger frame for use as an AFC Enabling Signal according to various embodiments.

FIG. 6 depicts a schematic diagram for an Enablement State machine according to various embodiments.

FIG. 7 shows a format of a 6 GHz Operation Information field used for advertising AFC related information according to various embodiments.

FIG. 8 shows a format of a Reduced Neighbor Report element used for indicating whether active scan is allowed in the 6 GHz band according to various embodiments.

FIG. 9 shows a format of a Neighbor Report element used indicating whether active scan is allowed in the 6 GHz band according to various embodiments.

FIG. 10 shows a format of a FILS (Fast Initial Link Setup) Discovery frame used for indicating whether active scan is allowed in the 6 GHz band according to various embodiments.

FIG. 11 depicts a flow diagram illustrating a mechanism for interference resolution in the 6 GHz band according to various embodiments.

FIG. 12 shows a format of a Cease Transmission Control frame used for interference resolution according to various embodiments.

FIG. 13 shows a format of a Cease Transmission element used for interference resolution according to various embodiments.

FIG. 14 shows a schematic example of a communication apparatus in accordance with various embodiments. The communication apparatus may be implemented as an AP or a STA and configured for 6 GHz band frequency coordination in accordance with various embodiments of the present disclosure.

FIG. 15 shows a flow diagram illustrating a communication method according to various embodiments.

FIG. 16 shows a configuration of a communication device, for example a communication apparatus or a station (STA) according to various embodiments.

FIG. 17 shows a configuration of a communication device, for example an AP, according to various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for enhanced direct link communication.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

The Notice of Proposed Rule Making (NPRM) [2] proposes to amend the rules in Title 47, Part 15, subpart E of the Code of Federal Regulations (CFR) [7] (Operation of U-NII devices in the 5 GHz band), some of the relevant rules are highlighted here as follows:
An AFC system is a system that automatically determines and provides lists of which frequencies are available for use by access points in the U-NII-5 sub-band (5.925-6.425 GHz) and the U-NII-7 sub-band (6.525-6.875 GHz).
A Client device is a U-NII device whose transmissions are generally under the control of an access point and that is not capable of initiating a network.
Access points operating in the U-NII-5 and U-NII-7 sub-bands shall access an AFC system to determine the available frequencies at their geographic coordinates prior to transmitting. Access points may transmit only on frequencies indicated as being available by an AFC system.
Operation of access points in the 6 GHz band is prohibited in moving vehicles such as cars, trains and aircrafts.
Operation in the 6 GHz band is prohibited for control of or communications with unmanned aircraft systems.

In addition, the FCC is also seeking comments whether client devices should be allowed to perform active scans in channels in the U-NII-5 and U-NII-7 sub-bands before receiving an “enabling signal”.

Similarly, regulatory bodies in other regions, e.g. ETSI in Europe are also actively planning to open up some portion of the 6 GHz band for unlicensed usage and may propose similar rules as above in their respective geographical regions.

Accordingly, the present invention proposes procedures for the operation of an 802.11 Basic Service Set (BSS) under the control of an AFC system in the 6 GHz band, where the focus is on the operation of 802.11 BSS in terms of interactions between APs and the AFC systems, as well as interactions between APs and STAs.

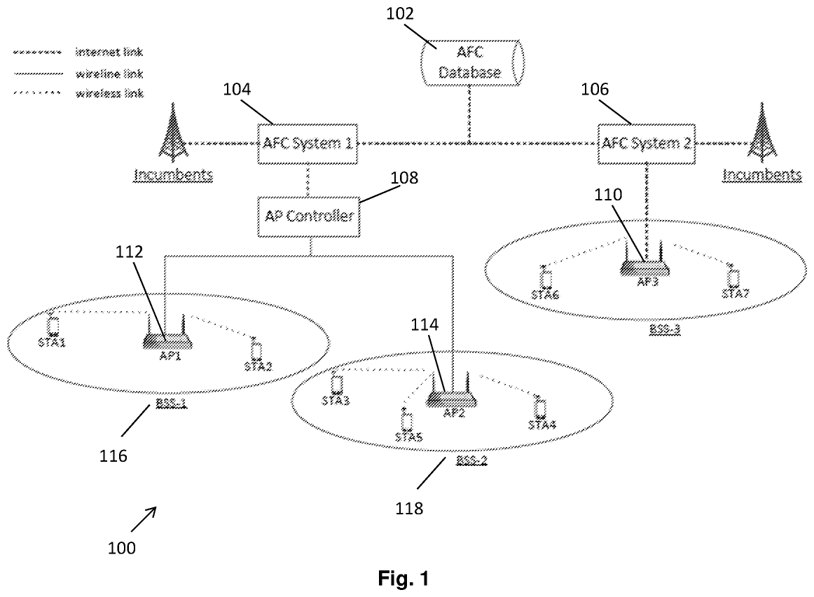

When operating in sections of the 6 GHz band (e.g. U-NII-5 or U-NII-7 sub-bands), an unlicensed user such as an IEEE 802.11 access point is required to consult an AFC system to seek approval for operating a wireless network. FIG. 1 depicts a schematic diagram 100 illustrating an example of wireless networks operating under an AFC system:
A central AFC database 102 contains information of all incumbent licensed users. The AFC database 102 may be a central or distributed database that maintains the records of all licensed users in a geographical region, including information of transmitters and receivers of incumbent users such as location, elevation, azimuth, elevation angle (tilt), assigned frequency, antenna size etc. and may be maintained by government regulators (e.g. FCC).
One or more AFC systems, for example 104 and 106. The AFC system may determine and provide lists of which frequencies are available for use by 802.11 BSS (e.g. based on calculations of potential interference caused by the BSS to the incumbents in the neighborhood). For this, the AFC system may use information such as the incumbent receivers' information from the AFC Database 102, as well as 802.11 AP's information such as location, elevation, maximum transmit power and other similar information. The AFC System may also record the frequencies used by the 802.11 BSS once chosen by the BSS and may also have connection with incumbent users' system (for e.g. for interference reporting etc.). The AFC system may be operated by private companies.
In the simplest case, a standalone access point such as AP 110 may directly connect to an AFC system (e.g. through the internet) to enquire about availability of frequency resources and to seek approval to operate a wireless network on the permitted frequencies.
In more advanced cases (e.g. in enterprise networks or managed networks), multiple access points such as AP 112 and 114 may go through a proxy device (e.g. an AP controller 108) to connect to the AFC system. The AP Controller 108 may be a physical device or may also be logical controller such as a cloud based AP Manager etc. The AP controller 108 may negotiate with the AFC system 104 on the behalf of one or more 802.11 BSS 116 and 118 and may represent multiple access points such as AP 112 and 114 when interacting with the AFC system 104. IEEE 802.11 wireless network and access points are shown in the figure as an example of unlicensed users. Other example of unlicensed users may be cellular networks with the base station acting as the access point and liaising with the AFC system.

An important difference between the AFC system in the U-NII-5 and U-NII-7 sub-bands and other similar database based systems such as TVWS (TV White Space) systems, is that in the in the TVWS spectrum, the database only maintains information about the licensed transmitters (e.g. TV broadcasters) but not about the receivers. Since the receivers are passive receivers (e.g. TV sets), it is not possible to record their information. As such in TVWS, as long as a licensed transmitter is operating in a geographic area in a certain frequency range, all areas in which the transmission signal could potentially be received are considered unusable for the TVWS devices/networks, regardless of actual presence of receiver devices. This may be considered an over protective system. However, in the U-NII-5 and U-NII-7 sub-bands, the licensed users are mostly Fixed Service point to point systems (e.g. fixed service microwave systems) and it is possible to maintain detailed information of all licensed receivers in the AFC database. This would mean that, upon providing an access point's information (such as antenna location, antenna height, transmission powers etc.), the AFC system may be able to accurately calculate whether the access point (and its client devices) would cause harmful interference to the licensed receivers. For example, if the unlicensed network happens to lie within the antenna boresight of the licensed receiver, and it is close enough to the receive antenna, the AFC system may determine that the unlicensed network will cause interference to the licensed user in the frequency range allocated to the licensed user. The AFC system may even make use of topographical information (such as terrain information, presence of tall buildings or trees etc.) to make even more accurate prediction of interference to the licensed users. Although such details are still under discussion, it is highly likely that the AFC systems will be required to have much more advanced interference calculation capabilities compared to earlier systems (such as TVWS). This means that a much higher reuse of the frequency spectrum can be expected in the 6 GHz band. On the other hand, this also means that the risk of inadvertent interference to the licensed user is also higher and this will require the AFC system to implement additional measures to protect the incumbent users in case of inadvertent interference, for example provisions for the incumbent users to report interference and the AFC system need to have the capability to quickly identify the unlicensed network causing the interference and to instruct it to stop the interfering transmissions.

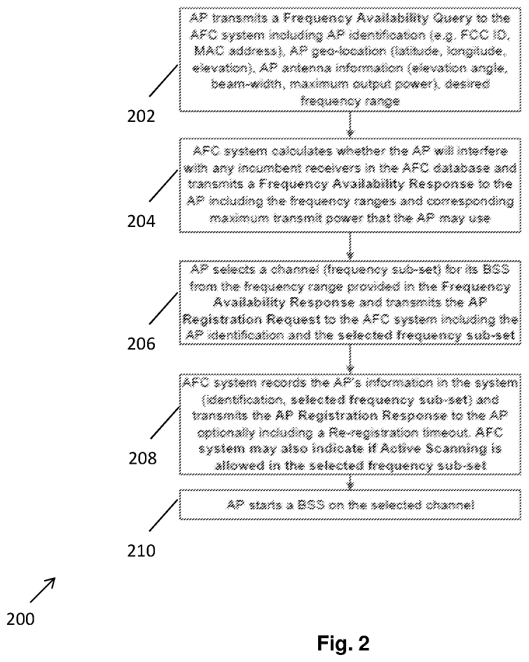

FIG. 2 shows a flow diagram 200 illustrating a method that an access point (AP) may use to start a wireless network (may also be called a Basic Service Set (BSS) or in general a Radio Local Area Network (RLAN)) in a regulated sub-band of the 6 GHz band (such as U-NII-5 and U-NII-7 sub-bands).

At 202, an AP may transmit a first message (for example a Frequency Availability Query) to an AFC system to enquire about the availability of a desired frequency range. The message may include AP identification (e.g. regulatory provided ID such as FCC ID or ETSI ID, WLAN MAC address etc.), AP geo-location (latitude, longitude, elevation), AP antenna information (elevation angle, beam-width, maximum output power) and the desired frequency range.

At 204, based on the AP's information, the AFC system may verify whether the AP is allowed to operate in that region and may also calculate whether the AP or any of the client devices under control of the AP will interfere with any incumbent receivers in the AFC database. The AFC system may transmit a second message (e.g. a Frequency Availability Response) to the AP to inform the result of the determination. The message may include the available frequency ranges that may be used by the AP for the RLAN and the corresponding maximum transmit power that may be used in the frequency range.

At 206, the AP may select a channel (frequency sub-set) for its BSS from the frequency range provided in the Frequency Availability Response and transmit a third message (e.g. an AP Registration Request) to the AFC system to register the unlicensed use of the frequency sub-set. The message may include the AP identification information and the selected frequency sub-set. This information may be used by the AFC system to identify the source of interference if an interference is reported by any licensed user.

At 208, the AFC system may record the AP's information in the system (identification, selected frequency sub-set) and transmit a fourth message (e.g. AP Registration Response) to the AP. The message may indicate the status of the registration request and optionally includes a Re-registration timeout. The Re-registration timeout may be a dynamic value decided by the AFC system or may also be a fixed value mandated by the regulatory body (e.g. 24 hours). AP may need to re-register itself before the timeout value in order to continue using the selected frequency. The AFC system may also indicate if Active Scanning is allowed in the selected frequency sub-set (i.e. if the client devices are allowed to transmit a probe request frame prior to receiving an indication from the AP that the channel may be used for transmissions). Alternatively, in a more general case, the AFC system may indicate whether an initial transmission is allowed from client devices prior to receiving an indication from the AP that the channel may be used for transmissions.

At 210, upon receiving the AP Registration Response with a successful status, the AP may proceed to start a BSS or a RLAN on the selected channel.

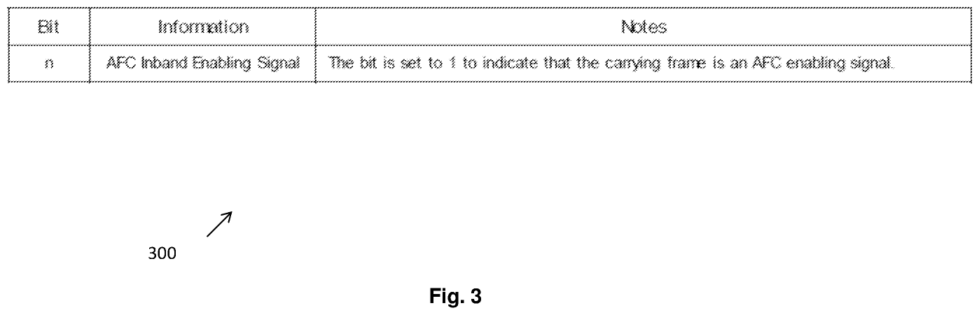

After an AP starts a BSS on a channel in the U-NII-5 and U-NII-7 sub-bands, the AP may need to periodically transmit a signal on the operating channel of the BSS to inform its associated client devices (STAs) or potential client devices that it is safe to use the channel for wireless communication with the AP. The signal may be known as an enabling signal or an authorization signal and so on. Although any frame that is periodically transmitted by the AP on the BSS's operating channel may be considered an enabling signal, for safety reasons an explicit signal, for example one bit, called AFC Inband Enabling Signal may be carried in the Beacon frames transmitted by the AP. FIG. 3 shows an example of the AFC Enabling Signal 300 according to various embodiments. When the AFC Enabling Signal 300 bit is set to 1, it may indicate that the frame carrying the AFC Enabling Signal is an AFC enabling signal.

As will be further explained below, it is also possible that other frames, for example Probe Response frames, FILS Discovery frames or even Trigger frame may also act as an enabling signal by carrying the AFC Inband Enabling Signal 300. Any one of these frames that carry the AFC Inband Enabling Signal 300 that is set to 1 may be considered an enabling signal by a receiving client device. It is possible that regulatory bodies may mandate that client devices are not allowed to transmit anything, including enquiry frames such as Probe Request frames, in the U-NII-5 and U-NII-7 sub-bands before receiving a valid enabling signal.

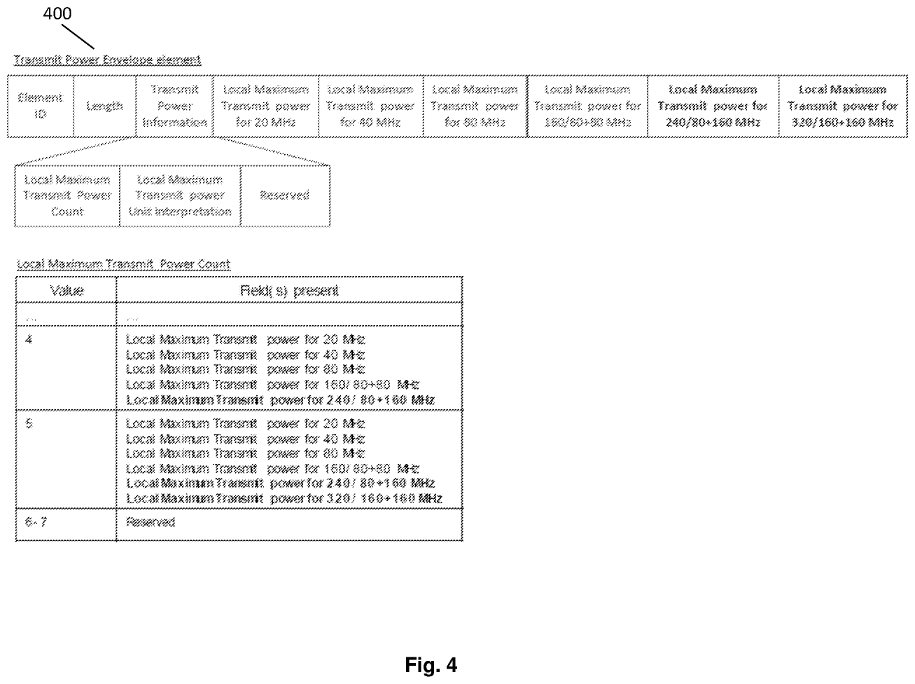

In addition to advertising the enabling signal, the AP may also advertise the Transmit Power limitation applicable in the operating channel of the BSS, for example by including a Transmit Power Envelope element in the Beacon and Probe Response frames. FIG. 4 shows a format of a Transmit Power Envelope element 400 according to various embodiments. The Transmit Power Envelope element 400 may include (or consist of) an Element ID field, a Length field, a Transmit Power Information field, a Local Maximum Transmit Power for 20 MHz field, a Local Maximum Transmit Power for 40 MHz field, a Local Maximum Transmit Power for 80 MHz field, a Local Maximum Transmit Power for 160/80+80 MHz field, a Local Maximum Transmit Power for 240/80+160 MHz field and a Local Maximum Transmit Power for 320/160+160 MHz field. Further, the Transmit Power Information field may include (or consist of) a Local Maximum Transmit Power Count field, a Local Maximum Transmit Power Unit Interpretation field and a reserved field.

The Transmit Power Envelope element 400 may indicate a local maximum transmit power for all applicable channel bandwidths including the 240 MHz or the 160+80 MHz channel and the 320 MHz or the 160+160 MHz channels that are being considered in the 802.11be Taskgroup. The Local Maximum Transmit Power Count field may indicate the number of the local maximum transmit power fields included in the element. For example, a value of n may indicate that n+1 fields are present, wherein the value of n may be as indicated in the table of FIG. 4. Each Local Maximum Transmit Power for X MHz field may be encoded as an 8-bit 2s complement signed integer in the range −64 dBm to 63 dBm with a 0.5 dB step. The value of 63.5 dBm may indicate 63.5 dBm or higher (i.e., no local maximum transmit power constraint). A client station may not be permitted to transmit at powers that exceed the value indicated in each applicable field of the Transmit Power Envelope element.

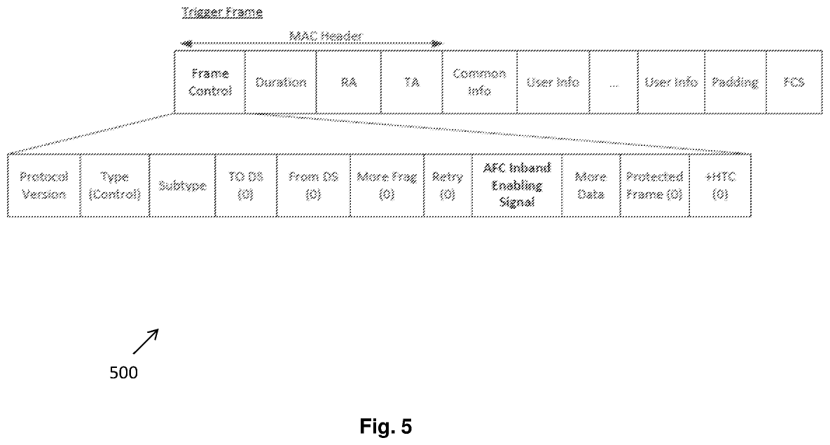

FIG. 5 shows a format of a Trigger frame 500 for use as an AFC Inband Enabling Signal according to various embodiments. The Trigger frame 500 may include (or consist of) a Frame Control field, a Duration field, a RA field, a TA field, a Common Info field, one or more User Info fields, a Padding field and a FCS field. The Frame Control field may include (or consist of) a Protocol Version field, a Type (Control) field, a Subtype field, a TO DS (0) field, a From DS (0) field, a More Frag (0) field, a Retry (0) field, an AFC Inband Enabling Signal field, a More Data field, a Protected Frame (0) field and a +HTC (0) field. All Trigger frames transmitted in the U-NII-5 and U-NII-7 sub-bands may be considered an AFC Enabling signal for the addressed STAs or the Trigger frames may explicitly carry the “AFC Inband Enabling Signal”, as shown with the AFC Inband Enabling Signal field in the Trigger frame 500. As an example, an unused bit e.g. B12 (Power Management) of the Frame Control field of a Trigger Frame may be overloaded as the “AFC Inband Enabling Signal”. Furthermore, trigger frames with the “AFC Inband Enabling Signal” set to 1 may be considered as a special Enabling Signal and allow an associated STA to stay in the AFC Enabled state without having to periodically receive the Beacon frames.

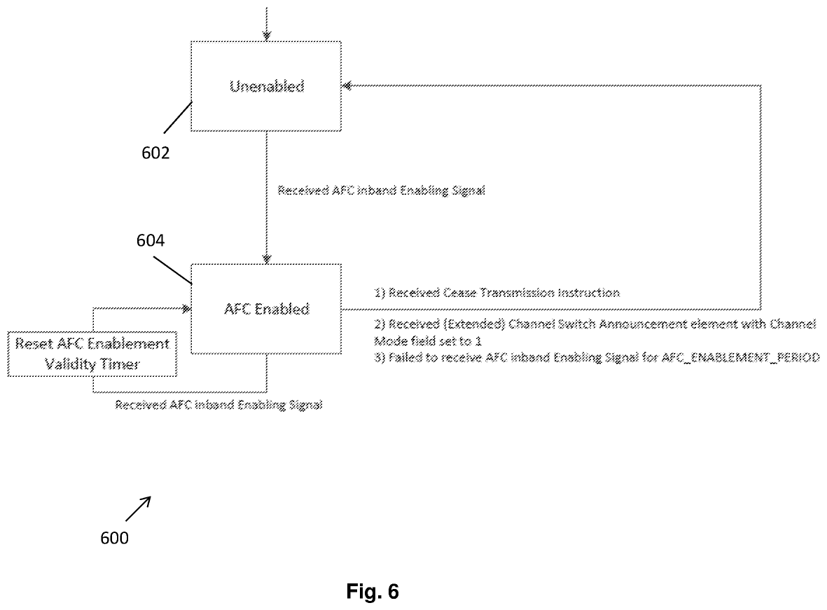

FIG. 6 depicts a schematic diagram for an Enablement State machine 600 according to various embodiments. The Enablement State machine 600 may be state which a non-AP STA may maintain to track its AFC enablement status in the U-NII-5 and U-NII-7 sub-bands and may comprise at least an Unenabled state 602 and an Enabled state 604. A non-AP STA in the Unenabled state 602 shall not transmit any frames in a channel in the U-NII-5 and U-NII-7 sub-bands, except probe request frames if Active scanning is allowed by the AFC system. Alternatively, in a more general case, if the AFC system indicates that certain category of initial transmission is allowed from client devices in the Unenabled state 602, the client device may be permitted to transmit a selected category of frames, e.g. generic advertisement service (GAS) public Action frames etc. These frames are pre-association frames used by client devices to discover the capabilities of the APs, or to discover the services provided by the backend system to which the AP is connected etc. Upon receiving an enabling signal such as an AFC Inband Enabling signal carried in a Beacon frame, Probe Response frame, FILS Discovery frame or a Trigger frame, the non-AP STA may transition to the Enabled state 604. Further, the non-AP STA may reset an AFC Enablement Validity Timer 606 to a value equal to a value of an AFC_ENABLEMENT_PERIOD every time it receives the AFC inband Enabling Signal. In an embodiment, the value of the AFC_ENABLEMENT_PERIOD may be received via a signal from an associated AP, wherein the value of the AFC_ENABLEMENT_PERIOD is defined by the AP. In another embodiment, the AFC_ENABLEMENT_PERIOD may be a fixed value that may be defined in the IEEE 802.11 standard.

When in the Enabled state 604, the non-AP STA may return to the Unenabled state 602 if, for example:
the non-AP STA receives a Cease Transmission instruction
the non-AP STA receives a (Extended) Channel Switch Announcement element with Channel Mode field set to 1
the non-AP STA failed to receive an AFC Inband Enabling Signal for a duration equal to AFC_ENABLEMENT_PERIOD. This may also apply to STAs in power save mode that are in doze state for AFC_ENABLEMENT_PERIOD or longer. The non-AP STA may move back to the AFC Enabled state upon receiving a Trigger frame carrying the AFC inband Enabling Signal. The Trigger frame may be in the format of the Trigger frame 500 as shown in FIG. 5.

In the U-NII-5 and U-NII-7 sub-bands, a client device e.g. a non-AP STA may be required to receive the enabling signal in regular intervals in order to stay in the AFC enabled state. Failing to receive a valid enabling signal for a certain period, e.g. for longer than an AFC_ENABLEMENT_PERIOD, may cause the device to move to the Unenabled state, in which it is not allowed to make any transmissions. For devices operating in the Active mode (i.e. not in power save mode), this may not be an issue since they can expect to receive the Beacon frames on a periodic basis. However, in certain power save modes, non-AP STAs are allowed to stay in the doze state without receiving any frame from the AP for long periods of time in order to save battery power. They may only wake up upon receiving an indication from the AP of buffered frames. In some other power save modes, e.g. when operating in Triggered Target Wake Time (TWT), the non-AP STA only wakes up during pre-determined windows and expects to receive a Trigger frame from the AP at the beginning of the TWT window. If the AFC_ENABLEMENT_PERIOD is short, a non-AP STA operating in the power save mode may be forced to wake up much more frequently to receive the enabling signal (e.g. the Beacon frames) and hence causing them to waste power. In order to allow the non-AP STAs in power save mode to continue staying in the AFC enabled state without having to wake up for Beacon frames, Trigger frames may also qualify as an enabling signal for associated non-AP STAs. Either all Trigger frames may be considered as enabling signal by default, or the Trigger frames may explicitly carry the AFC Inband Enabling Signal bit, for example in the Frame Control field of the Trigger frame 500 as shown in FIG. 5. Upon waking up and receiving a Trigger frame, if the non-AP STA is still in the AFC Enabled state, it may reset its AFC Enablement Validity Timer to AFC_ENABLEMENT_PERIOD, or if it had already moved to the Unenabled state, it may move back to the AFC Enabled state and proceed to transmit the uplink frames in response to the received Trigger frame.

By default, transmitting of any frames including discovery frames such as Probe Request frames is disallowed before receiving an AFC Enabling Signal. Transmitting Probe Request frames before receiving an AFC Enabling Signal is only allowed on channels that explicitly allow Active Scanning. An AP may indicate whether Active scanning is allowed prior to receiving AFC Enabling Signal, for example in a 6 GHz Operation Information field in the HE Operation element carried in a Beacon frame or Probe Response frame transmitted in the 6 GHz band. Alternatively, in a more general case, the AP may indicate that certain category of initial transmission (e.g. generic advertisement service (GAS) public Action frames, probe request frames) is allowed from client devices prior to receiving an AFC Enabling Signal.

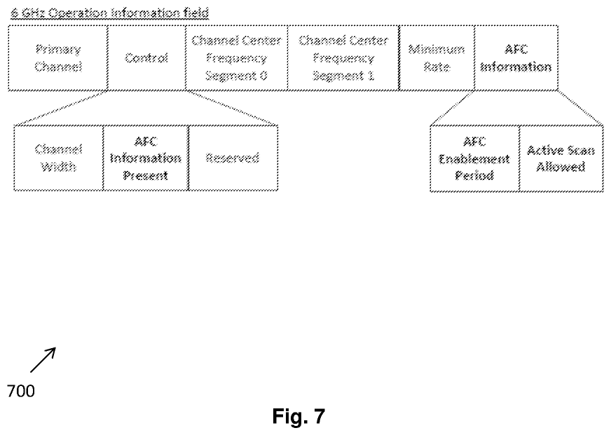

FIG. 7 shows a format of a 6 GHz Operation Information field 700 used for advertising AFC related information according to various embodiments. The 6 GHz Operation Information field 700 may include (or consist of) a Primary Channel field, a Control field, a Channel Center Frequency Segment 0 field, a Channel Center Frequency Segment 1 field, a Minimum Rate field and an AFC Information field. The Control field may include (or consist of) a Channel Width field, an AFC Information Present field that indicate whether the AFC Information field is present, and a Reserved field. The AFC Information field may include (or consist of) an AFC Enablement Period field and an Active Scan Allowed signal field. For example, a value of ‘0’ in the Active Scan Allowed field may indicate that Active Scan is not allowed on the indicated channel prior to receiving AFC enabling signal, while a value of ‘1’ may indicate that Active Scan is allowed on the indicated channel prior to receiving AFC enabling signal.

The AP may decide whether Active Scan is allowed based on explicit indication by the AFC system during the AP registration; or alternatively the AP may also make the decision implicitly for example based on the maximum transmit power allowed in the channel. If the maximum transmit power is below a certain threshold value, the AP may infer that an incumbent receiver may be nearby and thereby decide not to allow Active scan before receiving Enabling Signal.

When operating in the U-NII-5 and U-NII-7 sub-bands, in addition to other operation parameters, an AP may also advertise information relevant to the AFC operation in the Beacon frames, Probe Response frames transmitted in the 6 GHz band, for example, by including an AFC Information field in the 6 GHz Operation Information field within an HE Operation element or an EHT Operation element etc. Such a 6 GHz Operation Information field may be in the same format as the 6 GHz Operation Information field 700 as shown in FIG. 7. The presence of the AFC Information field implicitly indicates that the operation in the channels indicated in the 6 GHz Operation Information field are subject to control of an AFC system and a non-AP STA operating in a BSS operated by such APs need to follow the AFC state machine as described earlier and shown in FIG. 6. Among other parameters, the AFC Information field may carry the AFC Enablement Period field that indicate the value of AFC_ENABLEMENT_PERIOD, and the Active Scan Allowed field that indicates whether Active Scan is allowed (i.e. whether non-AP STAs are allowed to transmit Probe Request frames prior to receiving an enabling signal) on the operating channel of the BSS. For example, a value of ‘0’ in the Active Scan Allowed field may indicate that Active Scan is not allowed on the indicated channel prior to receiving AFC enabling signal, while a value of ‘1’ may indicate that Active Scan is allowed on the indicated channel prior to receiving AFC enabling signal. The information about the Active Scan may also be used by neighboring APs to compile their in-band or out of band Neighbor Report element or Reduced Neighbor Report element etc.

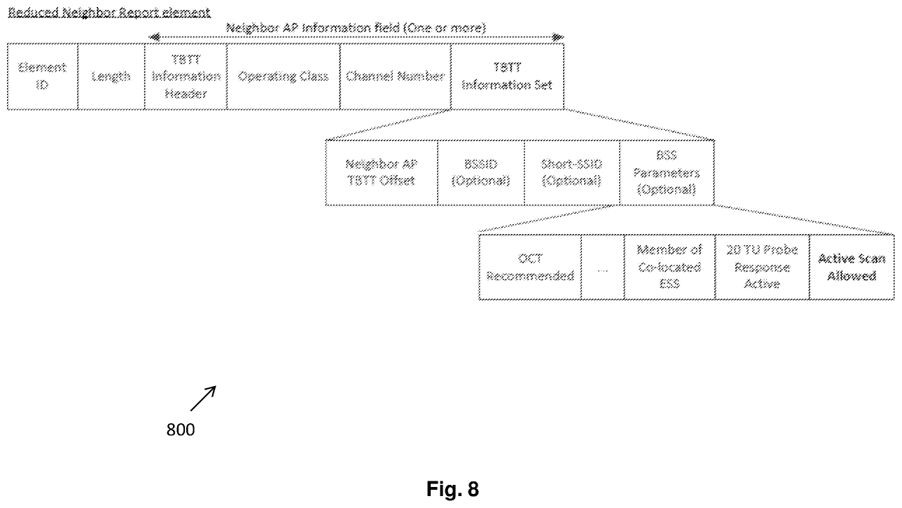

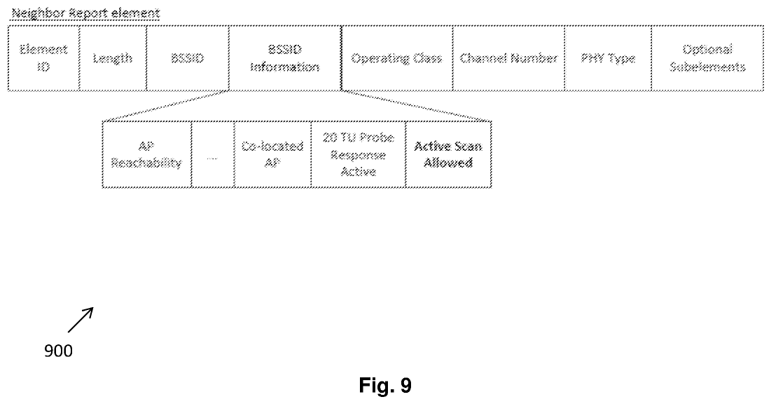

Possible formats of the Reduced Neighbor Report element and Neighbor Report element are shown in FIGS. 8 and 9 respectively. FIG. 8 shows a format of a Reduced Neighbor Report element used for indicating whether active scan is allowed in the 6 GHz band according to various embodiments. The Reduced Neighbor Report element may include (or consist of) an Element ID field, a Length field, a TBTT Information Header field, an Operating Class field, a Channel Number field and a TBTT Information Set field. The TBTT Information Set field may include (or consist of) a Neighbor AP TBTT Offset field, BSSID (Optional) field, a Short-SSID (Optional) field and a BSS Parameters (Optional) field. Further, the BSS Parameters (Optional) field may include (or consist of) an OCT Recommended field, Member of Co-located ESS field, 20 TU Probe Response Active field and an Active Scan Allowed field.

FIG. 9 shows a format of a Neighbor Report element 900 used for indicating whether active scan is allowed in the 6 GHz band according to various embodiments. The Neighbor Report element 900 may include (or consist of) an Element ID field, a Length field, a BSSID field, a BSSID Information field, an Operating Class field, a Channel Number field, a PHY Type field and an Optional Subelements field. The BSSID Information Set field may include (or consist of) an AP Reachability field, a Co-located AP field, a 20 TU Probe Response Active field and an Active Scan Allowed field.

6 GHz band being a newly opened up spectrum for unlicensed use, at present there are no unlicensed users in the band. Also, due to potential regulatory restrictions, there are ongoing attempts to reduce management frame transmissions in the band, especially frames related to initial discovery such as the Probe Request frames. Probe request frames are management frames used by non-AP STAs to discover the presence of APs operating in a channel. Various mechanisms have been introduced in the IEEE 802.11ax standard to reduce the management frame transmission related to initial AP discovery. One such mechanism is the out of band advertisement of a co-located AP. Typically an infrastructure AP device simultaneously operates as multiple APs in multiple frequency bands such as 2.4 GHz band, 5 GHz band and 6 GHz band; such APs are known as co-located APs. An AP operating the 2.4 GHz band or the 5 GHz band may advertise that the AP also operates in the 6 GHz band by including information about the 6 GHz co-located AP in a Reduced Neighbor Report (RNR) element, or in a Neighbor Report element in Beacon frames, Probe Response frames etc. The Reduced Neighbor Report element may be in the same format as the Reduced Neighbor Report element 800 as shown in FIG. 8, and the Neighbor Report element may be in the same format as the Neighbor Report element 900 as shown in FIG. 9.

In addition to operating parameters of the 6 GHz co-located AP, the Reduced Neighbor Report (RNR) element and the Neighbor Report element may also indicate whether Active Scan is allowed in the operating channel of the 6 GHz BSS of the co-located AP, such as by indicating a value in the Active Scan Allowed field as shown in the Reduced Neighbor Report element 800 and the Neighbor Report element 900. For example, a value of ‘0’ may indicate that Active Scan is not allowed on the indicated channel prior to receiving AFC enabling signal, while a value of ‘1’ may indicate that Active Scan is allowed on the indicated channel prior to receiving AFC enabling signal. A non-AP STA may receive information about co-located 6 GHz APs through Beacon frames in the 2.4 GHz or the 5 GHz band, or the non-AP STA may also solicit such information by transmitting a Probe Request frame to the 6 GHz AP in the 2.4 GHz or the 5 GHz band using On-Channel Tunneling (OCT) protocol. An AP may also advertise information about neighboring APs (i.e. not co-located APs) that operate in the 6 GHz band in the RNR element or the Neighbor Report element.

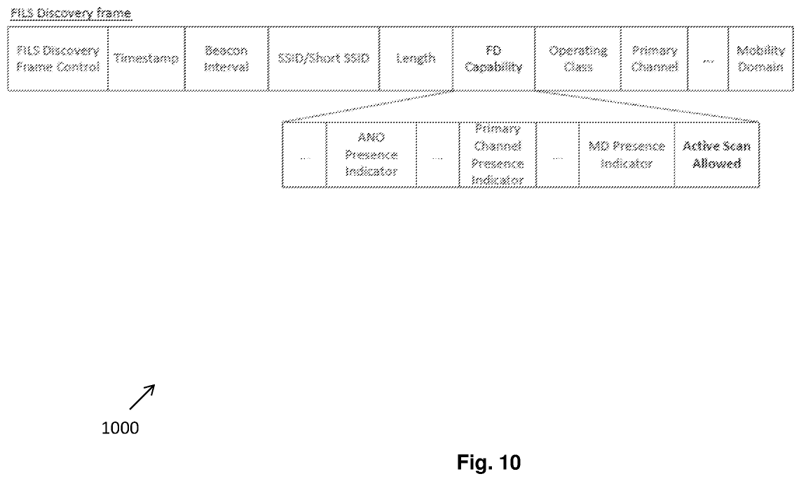

Another mechanism that has been introduced in the IEEE 802.11ax standard to reduce the management frame transmission related to initial AP discovery is the introduction of preferred scanning channels (PSC) in the 6 GHz band. The PSC are 20 MHz channels that occur at 80 MHz interval in the 6 GHz band and a 6 GHz AP may transmit Fast Initial Link Setup (FILS) Discovery frames on the PSC at regular intervals to advertise its operation in the 6 GHz band. FIG. 10 shows a format of a FILS Discovery frame 1000 according to various embodiments. The FILS Discovery frame 1000 may include (or consist of) a FILS Discovery Frame Control field, a Timestamp field, a Beacon Interval field, a SSID/Short SSIID field, a Length field, a FD Capability field, an Operating Class field, a Primary Channel field and a Mobility Domain field. The FD Capability field may include (or consist of) an ANO Presence Indicator field, a Primary Channel Presence Indicator field, MD Presence Indicator field and an Active Scan Allowed field.

The FILS Discovery frame is like a condensed version of the Beacon frames or Probe Response frames but transmitted much more frequently, for example once every 20 Time Units (TU); one TU being equal to 1024 microseconds. This allows a non-AP STA to perform a fast passive scan in the 6 GHz band by concentrating its passive scan on the PSCs. The PSC may be the same as the operating channel of a 6 GHz AP, but if it is different, the AP may also advertise whether Active Scan is allowed in its operating channel by including the Active Scan Allowed field in the FILS Discovery frames, such as, for example, the Active Scan Allowed field in the FILS Discovery frame 1000 in FIG. 10. For example, a value of ‘0’ in the Active Scan Allowed field may indicate that Active Scan is not allowed on the indicated channel prior to receiving AFC enabling signal, while a value of ‘1’ may indicate that Active Scan is allowed on the indicated channel prior to receiving AFC enabling signal.

When a non-AP STA receives the information about Active Scan in a channel that is different from the operating channel of an AP in the 6 GHz band, the non-AP STA shall not transmit anything (including Probe Request frames) in the operating channel in the 6 GHz band if the Active Scan Allowed field indicates that Active Scan is not allowed, but shall perform a passive scan to wait for an enabling signal (e.g. Beacon frames) in that channel. A non-AP STA may transmit Probe Request frames in the operating channel in the 6 GHz band only if the Active Scan Allowed field indicates that Active Scan is allowed in the channel.

It is highly likely that the AFC systems will be required to have much more advances interference calculation capabilities compared to earlier systems (such as TVWS) and hence a much higher reuse of the frequency spectrum can be expected in the 6 GHz band. However, this also means that the risk of inadvertent interference to the licensed user may also be higher and this will require the AFC system to implement additional measures to protect the incumbent users in case of inadvertent interference, for example provisions for the incumbent users to report interference and the AFC system need to have the capability to quickly identify the unlicensed network causing the interference and to instruct it to stop the interfering transmissions.

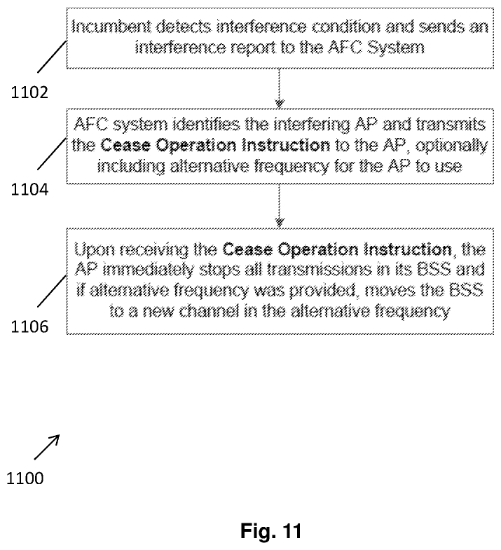

One example mechanism for such interference mitigation is described in FIG. 11, which depicts a flow diagram 1100 illustrating a mechanism for interference resolution in the 6 GHz band according to various embodiments. At 1102, an incumbent detects an interference condition and sends an interference report to an associated AFC System. At 1104, the AFC system identifies the interfering AP and transmits a Cease Operation Instruction to the AP, optionally including an alternative frequency for the AP to use. At 1106, upon receiving the Cease Operation Instruction, the AP immediately stops all transmissions in its BSS and if an alternative frequency was provided, moves the BSS to a new channel in the alternative frequency. However, if alternative frequency was not provided by the AFC system, and the AP is not able to identify another candidate channel immediately, the AP may instruct the associated non-AP STAs to cease all transmissions in the BSS by transmitting a Cease Transmission frame.

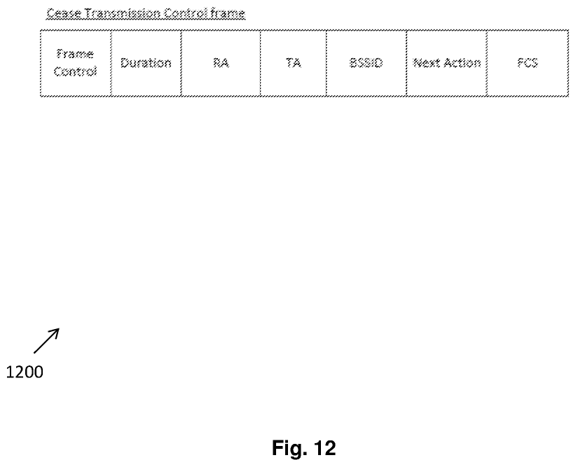

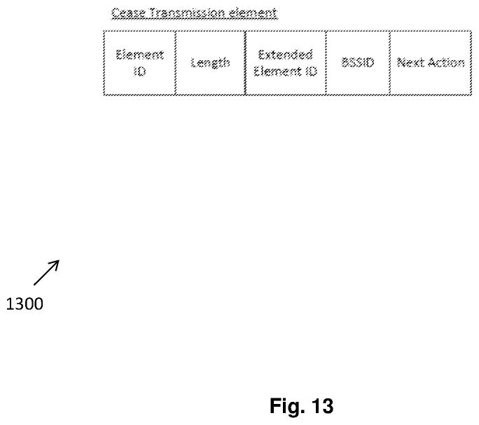

The Cease Transmission frame may, for example, be in a format of a Cease Transmission Control frame 1200 as shown in FIG. 12, or may be a frame that carries an element in a format of a Cease Transmission element 1300 (i.e. carried in management frames) as shown in FIG. 13. The Cease Transmission Control frame 1200 may include (or consist of) a Frame Control field, a Duration field, a RA field that identifies the receiver address, a TA field that identifies the transmitter address, a BSSID field that identifies the BSS, a Next Action field and a FCS field. The Cease Transmission element 1300 may include (or consist of) an Element ID field, a Length field, an Extended Element ID field, a BSSID field that identifies the BSS and a Next Action field.

In various embodiments, upon receiving an instruction to cease transmission from its associated AP, a non-AP STA shall immediately stop all transmissions in the channel and perform a next step as instructed by the AP. The next step may be indicated in the Next Action field that is present in the Cease Transmission Control frame 1200 of FIG. 12 and the Cease Transmission element 1300 of FIG. 13. An example of possible next steps is shown in the table 1 below.

TABLE 1

| Next Action field | Meaning |
|---|---|
| Channel Switch | STAs should cease transmission and wait for |
| Announcement | (Extended) Channel Switch Announcement |
| Pending | from the AP. |
| Look for alternative | STAs should cease transmission and |
| connections | considered themselves disassociated from the |
| | current BSS in the 6 GHz band and may look |
| | for alternative BSS or switch to 2.4/5 GHz band. |

For example, if the Next Action Field indicates that a channel switch announcement is pending, the non-AP STA shall wait for further instructions from the AP to move to a new channel provided in frames indicating Channel Switch or Extended Channel Switch. However, if the Next Action Field indicates the Next Action as Look for alternative connections, the non-AP STA may consider itself disassociated from the current BSS may look for an alternative BSS in other channels (in the 6 GHz band or even other bands). During this time, the non-AP STA shall not transmit anything in the existing operating channel.

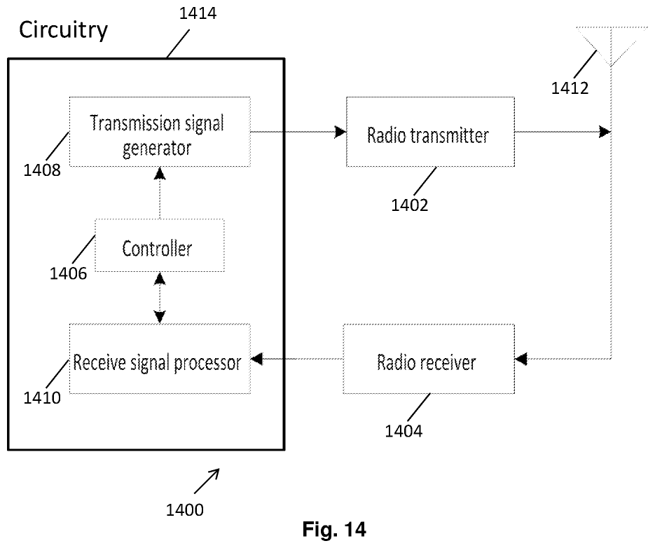

FIG. 14 shows a schematic, partially sectioned view of a communication apparatus 1400 according to various embodiments. The communication apparatus 1400 may be implemented as an AP or a STA according to various embodiments.

As shown in FIG. 14, the communication apparatus 1400 may include circuitry 1414, at least one radio transmitter 1402, at least one radio receiver 1404, and at least one antenna 1412 (for the sake of simplicity, only one antenna is depicted in FIG. 14 for illustration purposes). The circuitry 1414 may include at least one controller 1406 for use in software and hardware aided execution of tasks that the at least one controller 1406 is designed to perform, including control of communications with one or more other communication apparatuses in a wireless network. The circuitry 1414 may furthermore include at least one transmission signal generator 1408 and at least one receive signal processor 1410. The at least one controller 1406 may control the at least one transmission signal generator 1408 for generating frames (for example, probe request frames if the communication apparatus 1400 is a STA, and for example Reduced Neighbor Report Element, a Neighbor Report element, FILS Discovery frames, Beacon frames, Probe Response frames, cease transmission frames and Trigger frames if the communication apparatus 1400 is an AP) to be sent through the at least one radio transmitter 1402 to one or more other communication apparatuses and the at least one receive signal processor 1410 for processing frames (for example Reduced Neighbor Report Element, a Neighbor Report element, FILS Discovery frames, Beacon frames, Probe Response frames, cease transmission frames and Trigger frames if the communication apparatus 1400 is a STA, and for example probe request frames if the communication apparatus 1400 is an AP) received through the at least one radio receiver 1404 from the one or more other communication apparatuses under the control of the at least one controller 1406. The at least one transmission signal generator 1408 and the at least one receive signal processor 1410 may be stand-alone modules of the communication apparatus 1400 that communicate with the at least one controller 1406 for the above-mentioned functions, as shown in FIG. 14. Alternatively, the at least one transmission signal generator 1408 and the at least one receive signal processor 1410 may be included in the at least one controller 1406. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1402, at least one radio receiver 1404, and at least one antenna 1412 may be controlled by the at least one controller 1406.

The communication apparatus 1400, when in operation, provides functions required for 6 GHz frequency coordination. For example, the communication apparatus 1400 may be a STA, and the radio receiver 1404 may, in operation, receive information identifying an operating channel of an access point (AP) in a channel that is different from the operating channel, the information further indicating whether transmission of a probe request frame before receiving an enabling signal in the operating channel is allowed. The circuitry 1414 may, in operation, determine from the information whether to generate a probe request frame for transmission before receiving the enabling signal in the operating channel, wherein the circuitry 1414 is further configured to scan for the enabling signal in the operating channel without transmitting the probe request frame, based on a determination that transmission of the probe request frame before receiving the enabling signal in the operating channel is not allowed. Alternatively, in a more general case, the information from the AP may indicate that certain category of initial transmission (e.g. generic advertisement service (GAS) public Action frames, probe request frames) is allowed from client devices prior to receiving an enabling Signal. The_circuitry 1414 may, in operation, determine from the information whether to generate an allowed frame for transmission to the AP, or perform a passive scan to receive the enabling signal.

The information may be carried in a Reduced Neighbor Report Element, a Neighbor Report element or in a Fast Initial Link Setup (FILS) Discovery frame. The enabling signal may a Beacon frame, a Probe Response frame, a Fast Initial Link Setup (FILS) Discovery frame or a Trigger frame transmitted on the operating channel.

The communication apparatus 1400 may be further configured to maintain an Automated Frequency Coordination (AFC) state machine for the operating channel, which transitions to or continues in an enabled state upon receiving the enabling signal.

Further, the communication apparatus 1400 may be configured to start an enablement timer upon receiving the enabling signal, the enablement timer being set to an initial value equal to a value of an AFC_ENABLEMENT_PERIOD, wherein the AFC state machine continues in the enabled state for a duration based on the enablement timer.

The radio receiver 1404 may be further configured to receive a signal indicating the value of the AFC_ENABLEMENT_PERIOD from the AP, wherein the value of the AFC_ENABLEMENT_PERIOD is defined by the AP.

The radio transmitter 1402 may be configured to transmit one or more frames in the operating channel when the AFC state machine is in the enabled state.

The AFC state machine may transition to an unenabled state upon the enablement timer expiring, or when the receiver 1404 receives a cease transmission instruction from the AP, wherein the transmitter 1402 may be further configured to not transmit on the operating channel when the AFC state machine is in the unenabled state.

For example, the communication apparatus 1400 may be an AP configured to advertise information of its operating channel in a channel that is different from the operating channel, and the circuitry 1414 may, in operation, generate a signal comprising information indicating whether transmission of probe request frames before receiving an enabling signal in the operating channel is allowed. The transmitter 1402 may, in operation, transmit the generated signal to one or more communication apparatuses in the channel.

The signal may comprise information indicating AFC parameters of another AP.

The information may comprise an Active Scan Allowed field, the Active Scan Allowed field indicating, based on a value of the Active Scan Allowed field, whether transmission of probe request frames before receiving an enabling signal in the operating channel is allowed, and wherein the receiver 1404, in operation, receives the value of the Active Scan Allowed field for the operating channel from an Automated Frequency Coordination (AFC) system. The signal may further comprise information indicating a value of an AFC_ENABLEMENT_PERIOD.

The communication apparatus 1400 may be further configured to determine the value of the Active Scan Allowed field based on a maximum transmit power for the operating channel received from an Automated Frequency Coordination (AFC) system, such that transmission of probe request frames is not allowed when the maximum transmit power is lower than a threshold value.

Further, the circuitry may be further configured to generate a cease transmission instruction, and wherein the transmitter 1402 may be further configured to transmit the cease transmission instruction to associated STAs of the AP to cease transmissions on the operating channel.

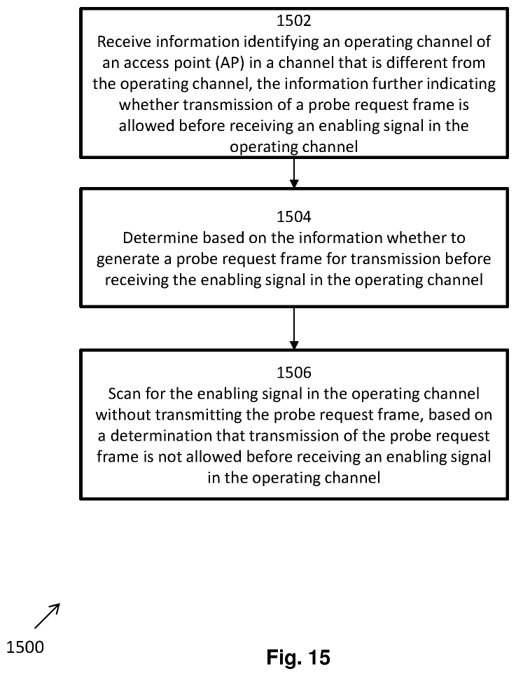

FIG. 15 shows a flow diagram 1500 illustrating a communication method according to various embodiments. In step 1502, information identifying an operating channel of an access point (AP) in a channel that is different from the operating channel may be received, the information further indicating whether transmission of a probe request frame is allowed before receiving an enabling signal in the operating channel. In step 1504, it may be determined based on the information whether to generate a probe request frame for transmission before receiving the enabling signal in the operating channel. In step 1506, scanning may commence for the enabling signal in the operating channel without transmitting the probe request frame, based on a determination that transmission of the probe request frame is not allowed before receiving an enabling signal in the operating channel.

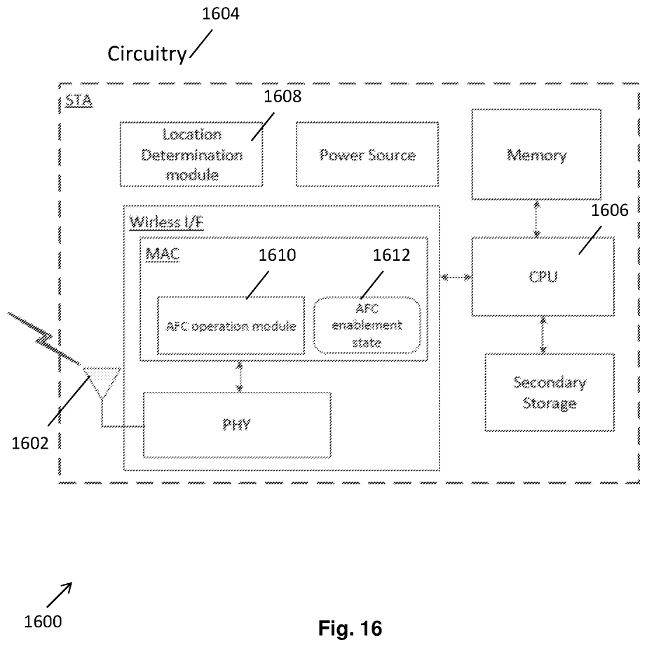

FIG. 16 shows a configuration of a communication device 1600, for example a communication apparatus, for example a STA, according to various embodiments. Similar to the schematic example of the communication apparatus as shown in FIG. 14, the communication apparatus 1600 in the schematic example of FIG. 16 includes at least one antenna 1602 with at least one radio transmitter and at least one radio receiver (for the sake of simplicity, the radio transmitter and receiver are not depicted in FIG. 16) and circuitry 1604. The circuitry 1604 may include at least one controller or CPU 1606 for use in software and hardware aided execution of tasks the CPU 1606 is designed to perform, including control of communication with other communication apparatuses such as another STA or an AP.

The circuitry 1602 may further include a location determination module 1608 which is responsible for determining the location of the communication device 1600 which may include the Latitude, Longitude information of its geo-location position. In some regulatory domains, the location information may be used by the AFC system to decide the frequency channels that may be used by the STAs for wireless communications. The circuitry 1602 may further include an AFC operation module 1610 which is responsible for maintaining the various parameters related to AFC operation, such as AFC_ENABLEMENT_PERIOD, maximum transmit power limits. The module may also be responsible for keeping track of the AFC enablement timer and ensuring that the STA receives enabling signals before the timer expires. The circuitry 1702 may further include an AFC enablement state module 1612 that maintains the AFC enablement state when operating in channels that require AFC operation.

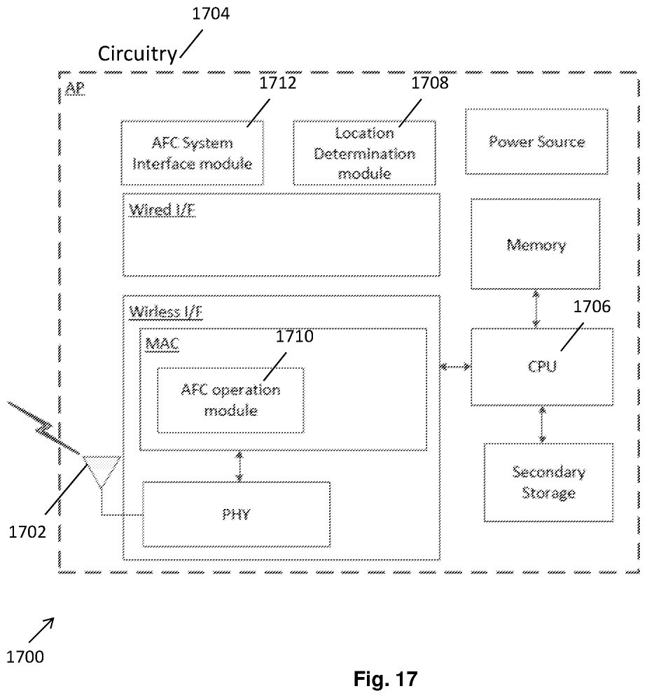

FIG. 17 shows a configuration of a communication device 1700, for example an AP, according to various embodiments. Similar to the schematic example of the communication apparatus as shown in FIG. 14, the communication apparatus 1700 in the schematic example of FIG. 17 includes at least one antenna 1702 with at least one radio transmitter and at least one radio receiver (for the sake of simplicity, the radio transmitter and receiver are not depicted in FIG. 17) and circuitry 1704. The circuitry 1704 may include at least one controller or CPU 1706 for use in software and hardware aided execution of tasks the CPU 1706 is designed to perform, including control of communication with other communication apparatuses such as a STA or another AP.

The circuitry 1702 may further include an AFC System Interface module 1712 that maintains the information necessary to communicate with the AFC system and acts as the gateway to the AFC system and the AFC database. The actual communication with the AFC system may go through the wired interface. The circuitry 1802 may further include a location determination module 1708 which is responsible for determining the location of the AP device which may include the Latitude, Longitude information of the AP's geo-location position as well as the AP's attitude from the ground. The location information may be used by the AFC system to decide the frequency channels that may be used by the AP and the STAs associated with the AP. The circuitry 1702 may further include an AFC operation module 1710 for maintaining the various parameters related to AFC operation, such as AFC_ENABLEMENT_PERIOD, maximum transmit power limits. The module may also be responsible for managing the channels that are in use by the STAs associated with the AP and may include transmission of enabling signals on the channels, transmission of the AFC parameters, transmission of Cease Transmission instructions etc.

As described above, the embodiments of the present disclosure provide an advanced communication system, communication methods and communication apparatuses that enable 6 GHz frequency coordination.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
a receiver, which, in operation, receives information identifying an operating channel of an access point (AP) in a channel that is different from the operating channel, the information further indicating whether transmission of a probe request frame before receiving an enabling signal in the operating channel is allowed; and
circuitry, which, in operation, determines from the information whether to generate a probe request frame for transmission before receiving the enabling signal in the operating channel; and
wherein the circuitry is further configured to scan for the enabling signal in the operating channel without transmitting the probe request frame, based on a determination that transmission of the probe request frame before receiving the enabling signal in the operating channel is not allowed.

2. The communication apparatus according to claim 1, wherein the information is carried in a Reduced Neighbor Report Element, a Neighbor Report element or in a Fast Initial Link Setup (FILS) Discovery frame.

3. The communication apparatus according to claim 1, wherein the enabling signal is a Beacon frame, a Probe Response frame, a Fast Initial Link Setup (FILS) Discovery frame or a Trigger frame transmitted on the operating channel.

4. The communication apparatus according to claim 1, wherein the communication apparatus is further configured to maintain an Automated Frequency Coordination (AFC) state machine for the operating channel, which transitions to or continues in an enabled state upon receiving the enabling signal.

5. The communication apparatus according to claim 4, wherein the communication apparatus is further configured to start an enablement timer upon receiving the enabling signal, the enablement timer being set to an initial value equal to a value of an AFC_ENABLEMENT_PERIOD, wherein the AFC state machine continues in the enabled state for a duration based on the enablement timer.

6. The communication apparatus according to claim 5, wherein the receiver is further configured to receive a signal indicating the value of the AFC_ENABLEMENT_PERIOD from the AP, wherein the value of the AFC_ENABLEMENT_PERIOD is defined by the AP.

7. The communication apparatus according to claim 4, further comprising a transmitter, which, in operation, transmits one or more frames in the operating channel when the AFC state machine is in the enabled state.

8. The communication apparatus according to claim 7, wherein the AFC state machine transitions to an unenabled state upon the enablement timer expiring, or when the receiver receives a cease transmission instruction from the AP, wherein the transmitter is further configured to not transmit on the operating channel when the AFC state machine is in the unenabled state.

9. An access point (AP) configured to advertise information of its operating channel in a channel that is different from the operating channel, the AP comprising:
circuitry, which, in operation, generates a signal comprising information indicating whether transmission of probe request frames before receiving an enabling signal in the operating channel is allowed; and
a transmitter, which, in operation, transmits the generated signal to one or more communication apparatuses in the channel.

10. The AP according to claim 9, wherein the information comprises an Active Scan Allowed element, the Active Scan Allowed element indicating, based on a value of the Active Scan Allowed element, whether transmission of probe request frames before receiving an enabling signal in the operating channel is allowed, and wherein the AP further comprises a receiver, which, in operation, receives the value of the Active Scan Allowed element for the operating channel from an Automated Frequency Coordination (AFC) system.

11. The AP according to claim 9, wherein the information comprises an Active Scan Allowed element, the Active Scan Allowed element indicating, based on a value of the Active Scan Allowed element, whether transmission of probe request frames before receiving an enabling signal in the operating channel is allowed, and wherein the AP is further configured to determine the value of the Active Scan Allowed element based on a maximum transmit power for the operating channel received from an Automated Frequency Coordination (AFC) system, such that transmission of probe request frames is not allowed when the maximum transmit power is lower than a threshold value.

12. The AP according to claim 10, wherein the signal further comprises information indicating a value of an AFC_ENABLEMENT_PERIOD.

13. The AP according to claim 9, wherein the circuitry is further configured to generate a cease transmission instruction, and wherein the transmitter is further configured to transmit the cease transmission instruction to associated STAs of the AP to cease transmissions on the operating channel.

14. The AP according to claim 9, wherein the signal further comprises information indicating AFC parameters of another AP.

15. A communication method, comprising:
receiving information identifying an operating channel of an access point (AP) in a channel that is different from the operating channel, the information further indicating whether transmission of a probe request frame is allowed before receiving an enabling signal in the operating channel;
determining based on the information whether to generate a probe request frame for transmission before receiving the enabling signal in the operating channel; and
scanning for the enabling signal in the operating channel without transmitting the probe request frame, based on a determination that transmission of the probe request frame is not allowed before receiving an enabling signal in the operating channel.
